(19) United States
(12) Patent Application Publication
(10) Pub. No.: US 2014/0354917 A1
(43) Pub. Date: Dec. 4, 2014

(54) LIQUID CRYSTAL DISPLAY DEVICE HAVING LASER LIGHT SOURCE UNIT AND BACKLIGHT MODULE OF SAME

(71) Applicant: HON HAI PRECISION INDUSTRY CO., LTD., New Taipei (TW)

(72) Inventor: YUNG-CHANG TSENG, New Taipei (TW)

(73) Assignee: HON HAI PRECISION INDUSTRY CO., LTD., New Taipei (TW)

(21) Appl. No.: 13/951,655

(22) Filed: Jul. 26, 2013

(30) Foreign Application Priority Data
May 28, 2013 (TW) 102118864

(51) Int. Cl. G02F 1/1335

(52) U.S. Cl. CPC G02F 1/133602; G02F 1/133606
USPC 349/64; 349/62; 362/97.2

(57) ABSTRACT

A liquid crystal display (LCD) device includes a backlight module and an LCD panel. The backlight module includes an array of light emitting units and an optical film unit. Each of the light emitting units includes a laser light source unit configured to emit a white light and a scanning mirror configured to reflect the white light to different directions to light a target area. The white light reflected by the scanning mirror is transmitted by the optical film unit and the LCD panel in sequence.

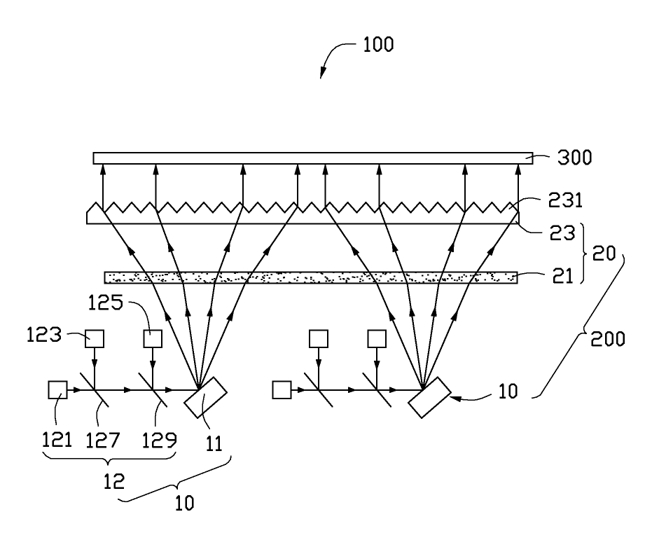

### BACKGROUND

1. Technical Field

The present disclosure relates to a liquid crystal display device and a backlight module of the liquid crystal display device.

2. Description of Related Art

Liquid crystal display devices (LCD device) may include cold cathode fluorescent lamps (CCFLS) or light emitting diodes (LEDS). However, light emitted by the CCFLS or the LEDS has a wide bandwidth, thus, the LCD device has a narrow color gamut.

Therefore, it is desirable to provide an LCD device and a backlight module of the LCD device which can overcome the limitations described.

### BRIEF DESCRIPTION OF THE DRAWINGS

Many aspects of the embodiments can be better understood with reference to the following drawings. The components in the drawings are not necessarily drawn to scale, the emphasis instead being placed upon clearly illustrating the principles of the present disclosure. Moreover, in the drawings, like reference numerals designate corresponding parts throughout the several views.

The FIGURE is a schematic view of a liquid crystal display device according to an exemplary embodiment of the present disclosure.

### DETAILED DESCRIPTION

The FIGURE shows a liquid crystal display device (LCD device) 100. The LCD device 100 includes a backlight module 200 and an LCD panel 300.

The backlight module 200 includes an array of light emitting units 10, and an optical film unit 20 above the light emitting units 10. The LCD panel 300 is positioned above the optical film unit 20 and is far away from the light emitting units 10 relative to the optical film unit 20.

Each light emitting unit 10 includes a scanning mirror 11 and a laser light source unit 12. The laser light source unit 12 emits white light. The laser light source unit 12 includes a first laser 121, a second laser 123, a third laser 125, a first dichroic mirror 127, and a second dichroic mirror 129. The first laser 121 emits a first monochromatic light, the second laser 123 emits a second monochromatic light, and the third laser 125 emits a third monochromatic light. The first monochromatic light, the second monochromatic light, and the third monochromatic light are different from each other in color. In this embodiment, the first monochromatic light is green, the second monochromatic light is blue, and the third monochromatic light is red.

The first dichroic mirror 127 is located in the light paths of the first laser 121 and the second laser 123. The first dichroic mirror 127 transmits the first monochromatic light and reflects the second monochromatic light. The second dichroic mirror 129 is located in the light paths of the first laser 121, the second laser 123, and the third laser 125. The second dichroic mirror 129 transmits the first monochromatic light, the second monochromatic light and reflects the third monochromatic light. In this way, the first monochromatic light, the second monochromatic light, and the third monochromatic light mix to form a white light irradiating the scanning mirror 11.

The scanning mirror 11 is a dual-axis micro electro-mechanical systems scanning mirror (MEMS scanning mirror). The dual-axis MEMS scanning mirror 11 rotates and reflects the white light to different directions to direct the white light emitted by the laser light source unit 12 to light a target area.

Light reflected by the scanning mirror 11 reaches the optical film unit 20. The optical film unit 20 includes a diffusion film 21 and a brightness enhancing film 23 both made of transparent resin. Diffusion particles are scattered in the diffusion film 21. Micro-prism structures 231 are formed on the brightness enhancing film 23. In this embodiment, the micro-prism structures 231 are V-shaped strips. The diffusion film 21 diffuses the white light. The brightness enhancing film 23 changes a transmission direction of the white light to a direction normal to a light emitting surface of the brightness enhancing film 23. The white light then is transmitted to the LCD panel 300.

The laser light source unit 12 can emit a white light with a narrow bandwidth smaller than 5 nanometers. Compared with an LCD device employing a cold cathode fluorescent lamp (CCFL) or a light emitting diode (LED), the LCD device 100 has a wider color gamut.

It will be understood that the above particular embodiments are shown and described by way of illustration only. The principles and the features of the present disclosure may be employed in various and numerous embodiments thereof without departing from the scope of the disclosure. The above-described embodiments illustrate the scope of the disclosure but do not restrict the scope of the disclosure.

What is claimed is:

1. A liquid crystal display (LCD) device comprising:
a backlight module comprising:
a plurality of light emitting units arranged in an array, each of the light emitting units comprising:
a laser light source unit configured to emit a white light; and
a scanning mirror configured to reflect the white light to different directions to light a target area; and
an optical film unit; and
an LCD panel, wherein the white light reflected by the scanning mirror is transmitted by the optical film unit and the LCD panel in sequence.

2. The LCD device of claim 1, wherein the laser light source unit comprises a first laser configured to emit a first monochromatic light, a second laser configured to emit a second monochromatic light, a third laser configured to emit a third monochromatic light, a first dichroic mirror configured to transmit the first monochromatic light and reflect the second monochromatic light, and a second dichroic mirror configured to transmit the first monochromatic light and the second monochromatic light and reflect the third monochromatic light, all of the first monochromatic light, the second monochromatic light, and the third monochromatic light mix to form the white light.

3. The LCD device of claim 2, wherein the first monochromatic light, the second monochromatic light, and the third monochromatic light are different from each other in color.

4. The LCD device of claim 3, wherein the first monochromatic light is green, the second monochromatic light is blue, and the third monochromatic light is red.

5. The LCD device of claim 1, wherein the optical film unit comprises a diffusion film.

6. The LCD device of claim 1, wherein the optical film unit comprises a brightness enhancing film.

7. The LCD device of claim 6, wherein the brightness enhancing film comprises a micro-prism structure.

8. A backlight module comprising:
a plurality of light emitting units arranged in an array, each of the light emitting units comprising:
a laser light source unit configured to emit a white light; and
a scanning mirror configured to reflect the white light to different directions to light a target area; and
an optical film unit configured to transmit the whit light reflected by the canning mirror.

9. The backlight module of claim 8, wherein the laser light source unit comprises a first laser configured to emit a first monochromatic light, a second laser configured to emit a second monochromatic light, a third laser configured to emit a third monochromatic light, a first dichroic mirror configured to transmit the first monochromatic light and reflect the second monochromatic light, and a second dichroic mirror configured to transmit the first monochromatic light and the second monochromatic light and reflect the third monochromatic light, all of the first monochromatic light, the second monochromatic light, and the third monochromatic light mix to form the white light.

10. The backlight module of claim 9, wherein the first monochromatic light, the second monochromatic light, and the third monochromatic light are different from each other in color.

11. The backlight module of claim 10, wherein the first monochromatic light is green, the second monochromatic light is blue, and the third monochromatic light is red.

12. The backlight module of claim 8, wherein the optical film unit comprises a diffusion film.

13. The backlight module of claim 8, wherein the optical film unit comprises a brightness enhancing film.

14. The backlight module of claim 13, wherein the brightness enhancing film comprises a micro-prism structure.
